(19) United States
(12) Patent Application Publication
(10) Pub. No.: US 2008/0162809 A1
(43) Pub. Date: Jul. 3, 2008

(54) Operating system-independent remote accessibility to disk storage

(76) Inventors: Michael A. Rothman, Puyallup, WA (US); Vincent J. Zimmer, Federal Way, WA (US)

Correspondence Address: INTEL CORPORATION;c/o INTELLEVATE, LLC, P.O. BOX 52050, MINNEAPOLIS, MN, 55402, US

(21) Appl. No.: 11/648,360

(22) Filed: Dec. 28, 2006

(51) Int. Cl. G06F 13/12

(52) U.S. Cl. 711/114

(57) ABSTRACT

A method, computer readable medium, and system are described. In one embodiment, the method comprises receiving a request to access data stored on at least one disk drive on a computer system, wherein the request originates from a location external to the computer system, and servicing the request without utilizing an operating system on the computer system.

### FIELD OF THE INVENTION

The invention relates to disk storage systems and remote manageability.

### BACKGROUND OF THE INVENTION

Storage systems on computer systems today are becoming increasingly complex to maintain data redundancy, security, etc. For example, a redundant array of independent disks (RAID) storage system, a Microsoft® Windows NT file system (NTFS), a High Performance File System (HPFS) and many other storage solutions typically have proprietary encoding schemes to achieve their data storage solutions. These data storage solutions, once installed, have drivers that boot up with the operating system (OS) to allow for a seamless interface to the storage device. Storage Networking Industry Association's DDF (Disk Data Format) has been an attempt at standardizing the format of RAID solutions, though this has not been universally adopted. Furthermore, other proprietary file systems have not been standardized at all. Solutions such as NTFS and HPFS are diverse and no consolidation of industry file systems has come close to succeeding.

There are many instances in a network environment where network administrators require access to an individual computer system. Remote network administration of individual computers on the network allows administrators to update and patch devices, drivers, and other important information on a computer system as well as perform functions such as data migration and redundant backups of important data. There are certain instances where “out-of-band” operation of a computer is necessary. Out-of-band commonly refers to the operation of a computer system without a complete boot to the OS. There are a number of out-of-band management controllers. One out-of-band solution is Intel® AMT (Active Management Technology). AMT enables a number of out-of-band of manageability scenarios including enabling the ME (Manageability Engine) to act as a proxy for interacting with the platform. As more remote solutions are enabled in network-connected computer systems, accessibility to a greater percentage of devices in an out-of-band computer is important. Though, the out-of-band solutions described above do not extend to inter-network data transfer from a storage device that does not have access to an OS. Apart from managing out-of-band systems voluntarily for updates, patches and backups, administrators and users also desire to manage systems that have crashed and are not able to boot properly to an OS.

### DESCRIPTION OF THE DRAWINGS

The present invention is illustrated by way of example and is not limited by the figures of the accompanying drawings, in which like references indicate similar elements, and in which:

FIG. 1 is a block diagram of a computer system which may be used with embodiments of the present invention.

FIG. 2 describes one embodiment of a computer system's hardware and software used to allow operating system-independent remote accessibility to disk storage.

FIG. 3 illustrates the similarities and differences of the layering that a disk drive access request requires when the request initiates from the operating system as opposed to when the request initiates from a remote device.

FIG. 4 is a flow diagram of one embodiment of a process to access disk storage through a virtual machine manager agent.

### DETAILED DESCRIPTION OF THE INVENTION

Embodiments of a method, computer readable medium, and system for operating system (OS)-independent remote accessibility to disk storage are described. In the following description, numerous specific details are set forth. However, it is understood that embodiments may be practiced without these specific details. In other instances, well-known elements, specifications, and protocols have not been discussed in detail in order to avoid obscuring the present invention.

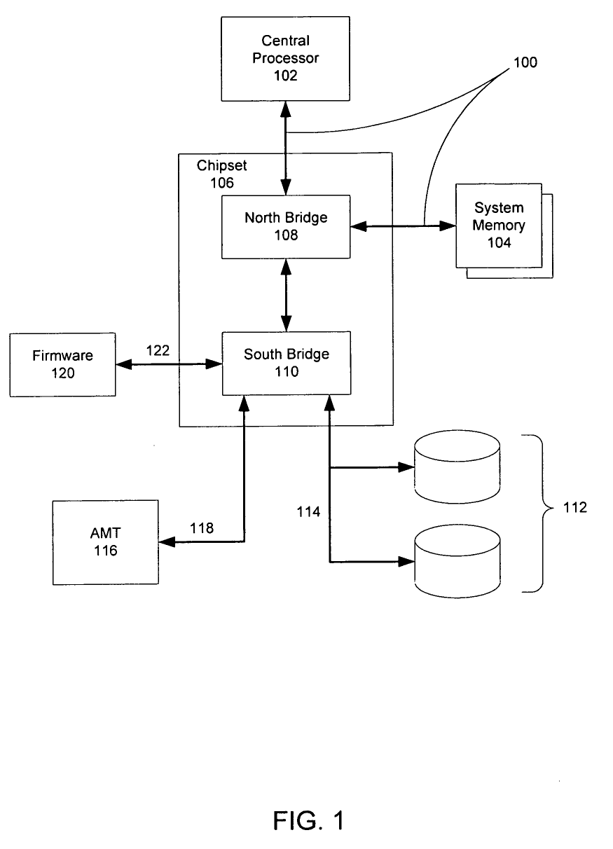

FIG. 1 is a block diagram of a computer system which may be used with embodiments of the present invention. The computer system comprises a processor-memory interconnect 100 for communication between different agents coupled to interconnect 100, such as processors, bridges, memory devices, etc. Processor-memory interconnect 100 includes specific interconnect lines that send arbitration, address, data, and control information (not shown). In one embodiment, central processor 102 may be coupled to processor-memory interconnect 100. In another embodiment, there may be multiple central processors coupled to processor-memory interconnect (multiple processors are not shown in this figure).

In one embodiment, central processor 102 has a single core 104. In another embodiment, central processor 102 has multiple cores (cores are not shown in this figure). Processor-memory interconnect 100 provides the central processor 102 and other devices access to the system memory 104. A system memory controller (not shown), controls access to the system memory 104. In one embodiment, the system memory controller is located within the north bridge 108 of a chipset 106. In another embodiment, a system memory controller is located on the same chip as central processor 102. The system memory controller is also not shown in FIG. 1. Information, instructions, and other data may be stored in system memory 104 for use by central processor 102 as well as many other potential devices. Additionally, north bridge 108 may contain a Manageability Engine (ME) in some embodiments to allow for out-of-band system operations. Out-of-band operations are usually considered to take place when the system has not booted to an OS.

North bridge 108 is coupled to south bridge 110 through a chipset interconnect. In one embodiment, the chipset interconnect is a Hub Link. South bridge 110 may be coupled to many I/O devices in different embodiments. In one embodiment, south bridge 110 is coupled to storage devices 112. Storage devices 112 may be a redundant array of independent disks (RAID) storage system. RAID storage systems can be utilized to provide speed of data storage access, redundancy of data, and other benefits in different embodiments. In another embodiment, data storage 112 is a single disk drive (not shown) that contains a proprietary, encrypted file system such as Microsoft® Windows NT file system (NTFS) or a High Performance File System (HPFS). In yet another embodiment, data storage 112 comprises multiple disk drives that contain a proprietary, encrypted file system.

In one embodiment, south bridge 110 is also coupled to an out-of-band management controller 116 through interconnect 118 to allow for remote management functionality of the system. In one embodiment, the out-of-band management controller is an Intel® Active Management Technology (AMT) device. Additionally, in one embodiment, a firmware device, such as firmware 120, is coupled to the south bridge 110 through interconnect 122 to allow for storing information related to a basic input/output system (BIOS) and instantiations of virtual machines (VMs) in the system.

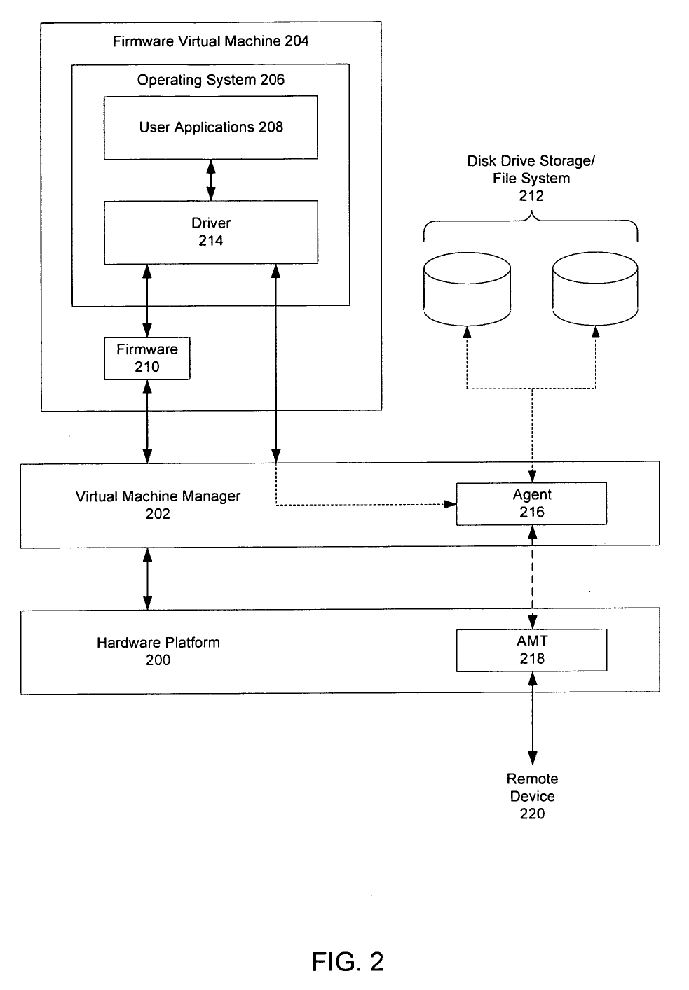

FIG. 2 describes one embodiment of a computer system's hardware and software used to allow operating system (OS)-independent remote accessibility to disk storage. In many embodiments, a hardware platform 200 includes one or more central processors, system memory, one or more chipsets, and other hardware devices that are common to a computer system. In one embodiment, a virtual machine manager (VMM) 202 accesses the hardware platform 200. In one embodiment, the VMM 202 resides in system memory in the hardware platform 200 directly interfaced to the hardware. In another embodiment, the VMM 202 resides in firmware within the computer system. In another embodiment, the VMM 202 resides in a dedicated hardware device coupled to a system motherboard. In yet other embodiments, the VMM 202 may reside in any other medium or location that is available.

In one embodiment, the VMM 202 manages one or more virtual machine instantiations on the hardware platform. For example, a firmware virtual machine 204 has it's key information stored within firmware 210 and interacts with the VMM 202. firmware virtual machine is comprised of an OS 206 that runs on the hardware platform 200, as well as user applications 208 that utilize the OS 206 to interface to lower levels of hardware. In one embodiment, the computer system has a storage device that utilizes a particular file system 212. The operating system 206 and user applications 208 utilize a driver 214 that has information related to any proprietary or encrypted file system in use on the drives themselves.

In one embodiment a file system agent 216 operates and resides within the VMM 202. The agent 216 has driver-type information to understand how to access the storage device/file system 212. In one embodiment, any access request to the storage device/file system 212 from any location is routed through the VMM 202. For example, a disk access to read or write information from/to one or more disks may utilize a logical block addressing (LBA) scheme. An LBA request must, in turn, be decoded to determine the specific physical location (i.e. drive, cylinder, head, sector information) on one or more of the disk drives in the storage system to read from or write to.

In one embodiment, the hardware platform is coupled to an out-of-band management controller 218. In this embodiment, network administration computers, network servers, and other valid remote devices may require access to the computer system shown in FIG. 2. In certain instances, the storage device/file system 212 must be accessible to the one or more remote devices. Thus, in one embodiment, the management controller 218 receives an access request to the storage device/file system 212 from a remote device 220. The management controller 218 routes the request directly to the agent 216 residing in the VMM 202. The agent 216 decodes the request and accesses the storage device/file system 212 to complete the request. In one embodiment, this entire sequence of events takes place when the OS 206 is shut down or malfunctioning. Thus, in one embodiment, the VMM 202, and the agent 216 running within the VMM 202, remain operational without an operational OS 206.

Thus, in this embodiment, the agent 216 controls accesses to the storage device/file system 212 from either the user applications 208 in OS 206 or from a remote device 220 through management controller 218. Furthermore, in this embodiment, the remote device 220 may contain a dissimilar storage medium and file system. The agent 216 functions as a type of proxy by allowing access to data stored on the storage device by a remote device that is not familiar with the file system utilized by the storage device. Additionally, once the storage device has been accessed, if the request was a read request, the agent also sends information back to the requester in a non-encrypted or encoded format so the requester can retrieve the information in a decoded format without requiring additional processing.

In one embodiment, the agent 216 receives information required to access the storage device/file system 212 from firmware. In this embodiment, the firmware may be updated at any given time with information relating to updated disk drive accessibility information if there is an update required. For example, if the file system has been updated, the management controller 218 may receive information from a network administrator on a remote device 220 that can be routed to the agent 216 for updating agent 216 information. In another embodiment, the first time the system boots up into the OS 206 and loads the driver 214 to access storage device/file system 212, the agent can download any required proprietary or encrypted information from the driver 214 for all future usage. In another embodiment, the agent 216 utilizes a universal disk data format (DDF) to access a RAID-based storage device/file system 212.

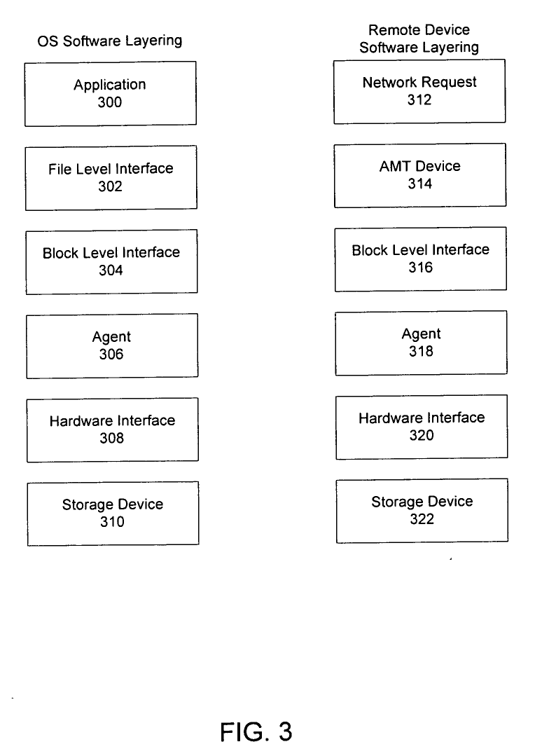

FIG. 3 illustrates the similarities and differences of the layering that a disk drive access request requires when the request initiates from the OS as opposed to when the request initiates from a remote device. In one embodiment, the OS software layering of the request starts at the application level 300 where a user application requests access to data stored on a disk. From the application level, the request is sent through the OS file level interface 302, this interface determines which file the request is targeting. Then the request is routed down through the VMM block level interface 304, which determines the logical block address of the file. The LBA address version of the request is then filtered to the agent 306, which converts the LBA address to a physical address. Next, the request with the physical address is sent by the agent to the actual physical hardware interface 308 from where the agent is located within the computer system and routed to where the physical storage device 310 is located. This routing may take place across one or more interconnects including, in different embodiments, the processor-memory interconnect, Hub-Link, Serial Advanced Technology Attachment (SATA), and others. Once the request reaches the storage device, it has arrived at its destination.

In another embodiment, the remote device software layering of a request starts at the network request level 312. The network request may come from any one or more of a number of network devices such as another computer system, a handheld device, a server, or others. In one embodiment, a network administrator remotely requests access to the storage device to transfer files to a second computer elsewhere on the network. The network request 312 is received by the computer system through the management controller 314. The management controller determines that the request is an access to a storage device on the local system where the management controller is located and routes the request to the VMM block level interface 316, which determines the logical block address of the file. The LBA address version of the request is then filtered to the agent 318, which converts the LBA address to a physical address. Next, the request with the physical address is sent by the agent to the actual physical hardware interface 320 from where the agent is located within the computer system and routed to where the physical storage device 322 is located. This routing may take place across one or more interconnects including, in different embodiments, the processor-memory interconnect, Hub-Link, Serial Advanced Technology Attachment (SATA), and others. Once the request reaches the storage device, it has arrived at its destination.

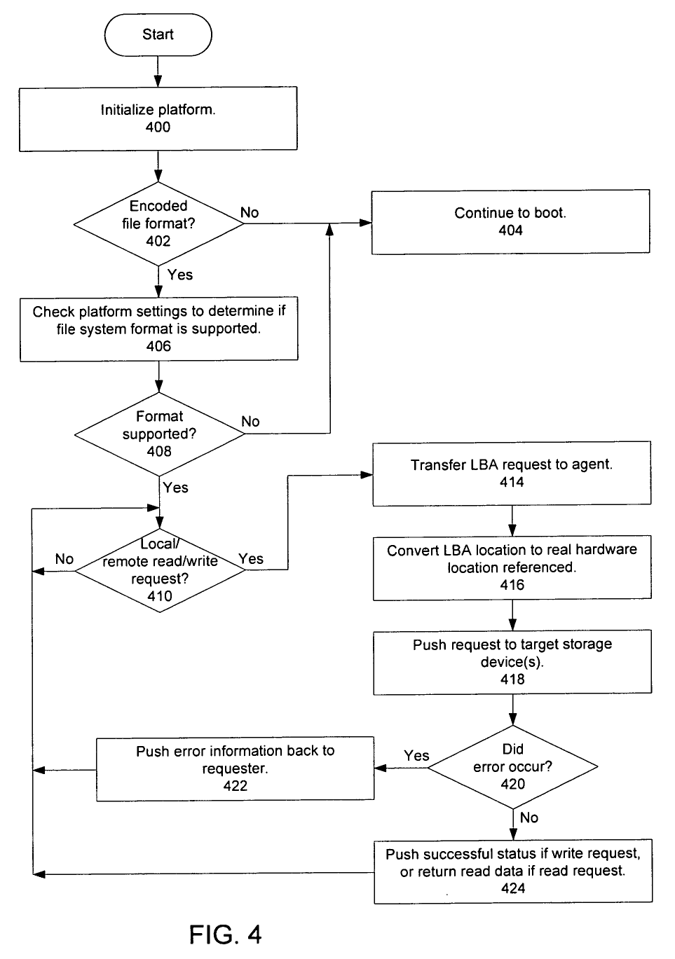

FIG. 4 is a flow diagram of one embodiment of a process to access disk storage through a VMM agent. The process is performed by processing logic that may comprise hardware (circuitry, dedicated logic, etc.), software (such as is run on a general purpose computer system or a dedicated machine), or a combination of both. Referring to FIG. 4, the process begins by processing logic initializing the hardware platform 400 (processing block 400). In one embodiment, initializing the platform includes performing pre-OS boot procedures such as booting the BIOS and checking what devices are connected to the platform.

Next, processing logic determines if the file format on the storage device or devices connected to the platform are encoded (processing block 402). In one embodiment, the storage device on the platform is a RAID file storage system that requires a specific algorithm to decode requests for storing information across one or more of the RAID stripes. In other embodiments, the storage device is a disk drive that has an encoded NTFS, HPFS, or other proprietary or encoded resident file system.

If there is no encoded file format, then processing logic continues to boot the system (processing block 404). In one embodiment, if the storage system is not encoded, no further processing is necessary to allow for local and remote access to the file system. Otherwise, if processing logic determines that the file system format is encoded, then processing logic checks the platform settings to determine if the encoded file system format that was found is a supported format (processing block 406). If the format is not supported, processing logic allows the platform to continue to boot (processing block 404).

Alternatively, if the format is supported, then processing logic waits for a local or remote request to the file system (processing block 410). Processing logic continues to wait for an access request until one arrives. At that point, processing logic transfers the LBA request to the agent (processing block 414). Then processing logic converts the LBA location to the real hardware location that is referenced (processing block 416). In other embodiments, the request is not in an LBA format, but rather in any other acceptable format for locating a file on a file system. In these embodiments, processing logic will proceed exactly as if it were an LBA format except the conversion routine will be different. Returning to FIG. 4, processing logic continues by pushing the request to the target storage device or devices (processing block 418).

Next, processing logic determines if there was an error in accessing the data for the request (processing block 420). If there was an error, processing logic pushes the error information back to the requester (processing block 422). Otherwise, if there was not an error, processing logic pushes the successful status if the request was a write request or returns the read data if the request was a read request (processing block 424). Whether or not there was an error, after the information and status is pushed back to the requester, processing logic returns to block 410 where it waits for another local or remote request and the process is finished. In any event, processing logic allows access to the target storage device without requiring access to the OS or the driver residing at the OS-level.

Thus, embodiments of a method, computer readable medium, and system for operating system (OS)-independent remote accessibility to disk storage are described. These embodiments have been described with reference to specific exemplary embodiments thereof. It will be evident to persons having the benefit of this disclosure the various modifications and changes may be made to these embodiments without departing from the broader spirit and scope of the embodiments described herein. The specification and drawings are, accordingly, to be regarded in an illustrative rather than a restrictive sense.

What is claimed is:

1. A method, comprising:
receiving a request to access data stored on at least one disk drive on a computer system, wherein the request originates from a location external to the computer system; and
servicing the request without utilizing an operating system on the computer system.

2. The method of claim 1, wherein receiving a request further comprises receiving the request by an agent residing in a virtual machine manager running on the computer system.

3. The method of claim 2, further comprising an out-of-band management controller device receiving the request and routing the request to the agent.

4. The method of claim 2, further comprising a network interface card receiving the request and routing the request to the agent.

5. The method of claim 1, wherein the data is stored in a redundant array of independent disks (RAID) file system.

6. The method of claim 1, further comprising servicing the request without utilizing a driver residing in the operating system.

7. A computer readable medium having embodied thereon instructions, which when executed by a computer, results in the computer performing a method comprising:
receiving a request to access data stored on at least one disk drive on a computer system, wherein the request originates from a location external to the computer system; and
servicing the request without utilizing an operating system on the computer system.

8. The computer readable medium of claim 7, wherein receiving a request further comprises receiving the request by an agent residing in a virtual machine manager running on the computer system.

9. The computer readable medium of claim 8, further comprising an out-of-band management controller receiving the request and routing the request to the agent.

10. The computer readable medium of claim 8, wherein receiving a request further comprises a network interface card receiving the request and routing the request to the agent.

11. The computer readable medium of claim 7, wherein the data is stored in a redundant array of independent disks (RAID) file system.

12. The computer readable medium of claim 7, further comprising servicing the request without utilizing a driver residing in the operating system.

13. A system, comprising:
an interconnect;
a processor coupled to the interconnect;
a chipset coupled to the interconnect;
one or more hard disk drives coupled to the interconnect;
a memory coupled to the interconnect, the memory adapted for storing instructions, which upon execution by the processor, receives a request to access data stored on at least one of the one or more disk drives, wherein the request originates from a location external to the system, and services the request without utilizing an operating system on the system; and
an out-of-band management controller coupled to the interconnect;

14. The system of claim 13, further comprising a virtual machine manager running in the memory.

15. The system of claim 14, wherein receiving a request further comprises receiving the request by an agent residing in the memory within the virtual machine manager.

16. The system of claim 15, further comprising the out-of-band management controller receiving the request and routing the request to the agent.

17. The system of claim 15, further comprising a network interface card operable to receive the request and route the request to the agent.

18. The system of claim 13, wherein the data is stored in a redundant array of independent disks (RAID) file system on at least one of the one or more hard disk drives.

19. The system of claim 13, further operable to service the request without utilizing a driver residing in the operating system.

20. The system of claim 13, further comprising a second processor coupled to the interconnect.
